(19) United States
(12) Patent Application Publication
(10) Pub. No.: US 2003/0016990 A1
(43) Pub. Date: Jan. 23, 2003

(54) Puppet arm connection and movement system

(76) Inventors: John P. Cary, Ypsilanti, MI (US); David Ray Pannabecker, Elkhart, IN (US)

Correspondence Address: John P. Cary, 4800 Merritt Rd, Ypsilanti, MI, 48197, US

(21) Appl. No.: 09/903,941

(22) Filed: Jul. 12, 2001

(51) Int. Cl. F16D 1/12; F16D 3/00

(52) U.S. Cl. 403/119

(57) ABSTRACT

A thin plastic material base (10) with a tube (20) and clip (40) assembly inserted into said base and secured to said base. Said base (10) may be encased in a foam material to provide for support, shape and proper alignment when used in an internal application. In addition a wire with a ground end which can be inserted into said tube (20) and clip (40) assembly to provide for a secure connection while allowing for rotational movement.

### CROSS-REFERENCE TO RELATED APPLICATIONS

Not applicable.

### STATEMENT REGARDING FEDERALLY SPONSORED

Not Applicable

### BACKGROUND—FIELD OF INVENTION

This invention relates to hand-held puppet arm manipulation, specifically to those puppets commonly referred to as rod-arm puppets.

### BACKGROUND—DESCRIPTION OF PRIOR ART

Over the past 40 years, hand puppets using rod arms have become increasingly popular. Rod design however, has remained essentially static. The standard for puppet arm manipulation has been a wire with a securement device externally attached (elastic, plastic cable ties, etc). One end of the rod is secured to the puppet's wrist joint. The opposite end is held by the puppeteer. Disadvantages of this system include:

a) Eventual damage to the puppet's external fabric (skin).

b) Compression damage to wrist materials.

c) Rod arm disconnection during inappropriate times such as live performance.

d) Limited range of motion of the puppet hand, wrist, arm, and shoulder joints.

e) An obvious wrist bracelet of elastic (the secure device) that may detract visually.

f) Anatomically inappropriate arm positions (distorted) at inappropriate times if the rod is accidentally dropped but remains attached.

Semi-permanent and permanent rods are also available. They require a device (i.e. alligator clip) implanted into the puppet's wrist or hand. This method also has disadvantages that include, but are not limited to:

a.) Eventual fabric damage at site of insertion.

b.) Permanent attachment without the ability to remove rod during storage.

c.) Rod arm disconnection during inappropriate times such as live performance.

d.) Anatomically inappropriate arm positions (distorted) at inappropriate times if the rod is accidentally dropped but remains attached.

e.) Limited range of motion of the puppet hand, wrist, arm, and shoulder joints.

### SUMMARY

Present puppet rod technology includes straight rods attached permanently or semi-permanently, either externally or internally.

### OBJECTS AND ADVANTAGES

The present invention has several objects and advantages:

a) To provide a rod arm movement system allowing expanded range of motion that is more realistic.

b) To provide movement of the puppet arm in a vertical line while the rod remains vertical.

c) To provide for pronation and supination (rotation) of the wrist joint and thus the hand.

d) To provide a rod arm/puppet connection that does not deteriorate the materials or fabric of the puppet arm.

e) To provide a rod arm/puppet connection that does not cause compression of the wrist joint.

f) To provide a rod arm/puppet connection without an external bracelet or other securing device that detracts visually.

g) To provide a secure rod arm/puppet connection that can be intentionally disconnected as needed.

h) To provide a secure rod arm/puppet connection that cannot become disconnected without intent.

i) To provide a naturally positioned arm and hand if the rod is accidentally dropped.

Further objectives and advantages are to provide a puppet wrist and rod arm manipulation system that can be built to scale and incorporated into any rod arm puppet, inexpensively without modification to the puppet hand/wrist joint.

### DRAWING FIGURES

FIG. 1 shows the completed puppet arm insert inside a puppet's arm, along with a rod.

FIG. 2 shows an isometric exploded view of the insert, along with a rod

FIG. 3A shows top, side and bottom views of the insert

FIG. 3B shows an isometric view of the completed insert assembly, along with a rod

REFERENCE NUMERALS IN DRAWINGS

| | |
|---|---|
| 10 | Sintra |
| 25 | Slot in brass tube |
| 40 | Hair pin clip |
| 60 | Music wire (puppet arm rod) |
| 20 | Brass tube |
| 30 | Bolt retainer |
| 50 | Backer rod |

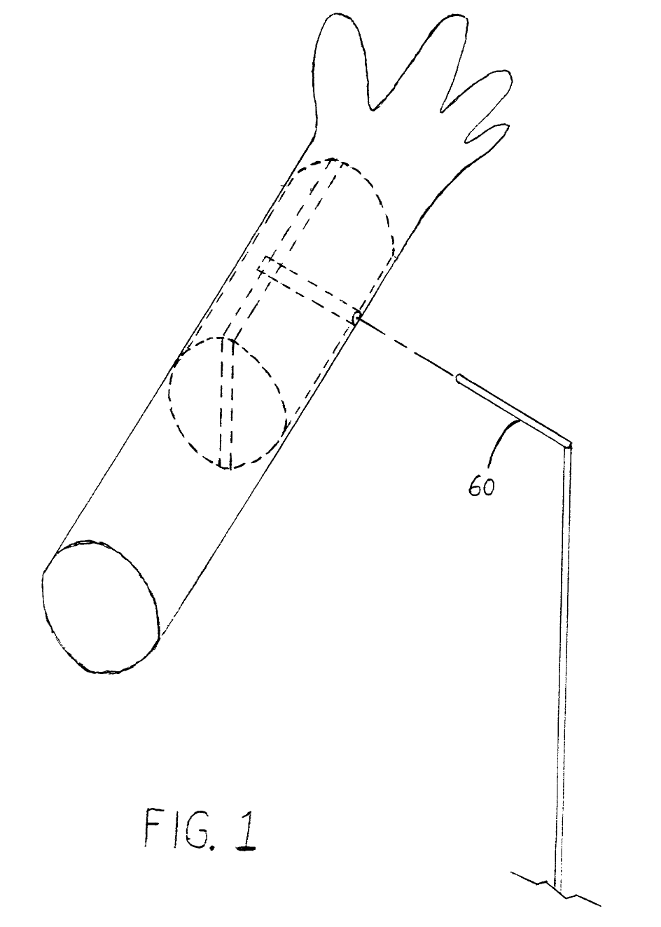

### DESCRIPTION—FIGS. 1, 2, 3A and 3B—PREFERRED EMBODIMENT

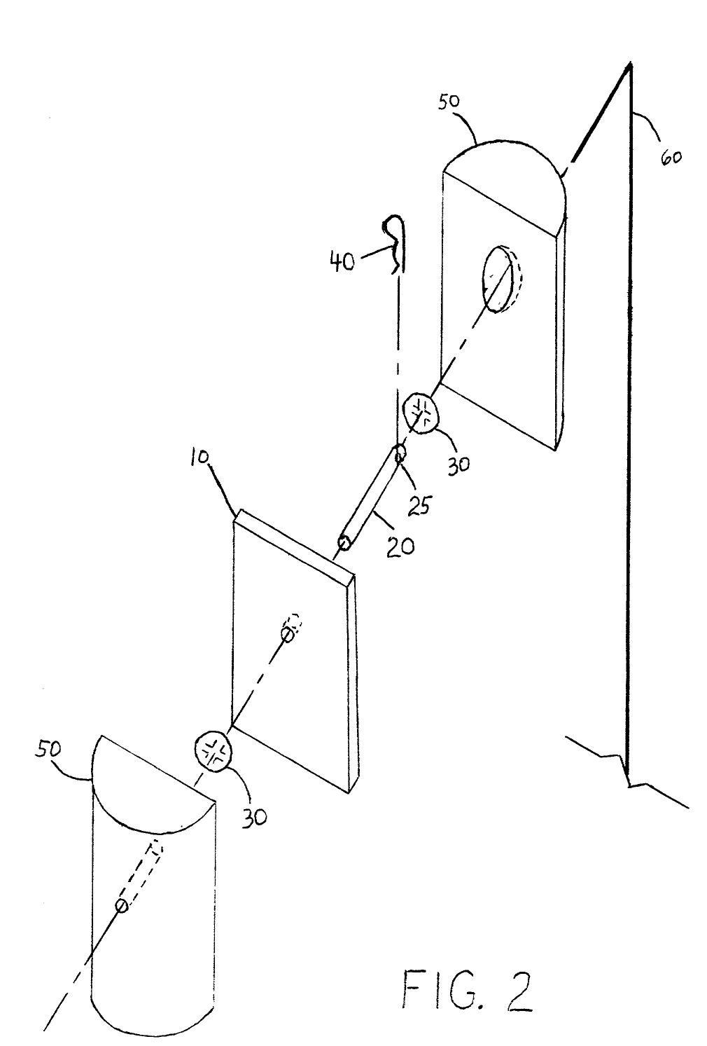

A preferred embodiment of the device of the present system is illustrated in FIG. 1. The puppet arm and wrist manipulation system is illustrated in an exploded isometric view in FIG. 2. The system consists of two parts. Part 1 is the wrist insert, which includes:

1) 1¼ inch diameter backer rod (50) split lengthwise in half.

2) ⅛ inch thick sintra (10) rectangle 2 inch×1 3/16 inch.

3) 0.047 inch×19/32 inch hair pin clip (40).

4) 2 number 6 bolt retainers (30).

5) ⅛ inch diameter×1 inch brass tube (20) with a 0.047 inch wide×0.035 deep slot (25) cut 1/16 of an inch from the bottom end of the tube.

6) Common hot glue.

Part 2 consists of a 3/32 inch diameter wire rod (60). The rod (60) is ground to a dull point at one end and bent to a 90 degree angle 1⅛ inches from the ground end. Total wire rod length is traditionally 21 inches including a handle.

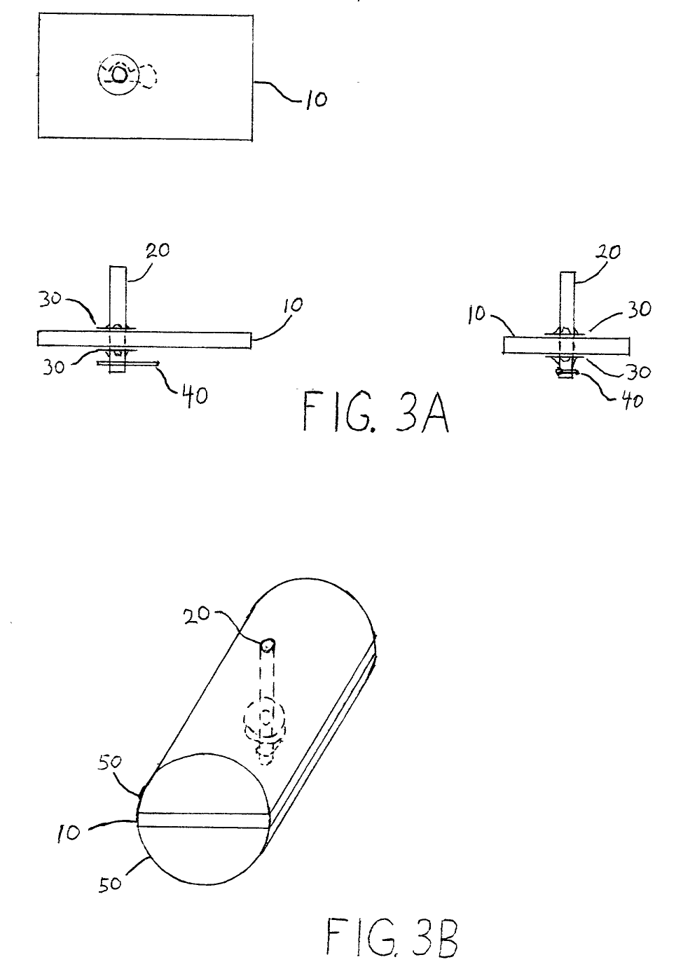

As shown in FIG. 3A, the wrist insert has a base of sintra (10) or a similar material. A ⅛ inch diameter drilled hole is located ¾ of an inch from one end and ⅝ of an inch from one side of the sintra (10). The brass tube (20) protrudes ⅝ of an inch from the top of the sintra (10) and ¼ of and inch from the bottom of the sintra (10). Two number 6 bolt retainers (30) secure the brass tube (20) to the sintra (10) on the top and bottom. The straight side of the hairpin clip (40) is attached to the brass tube (20) with the straight side in the slot parallel to the sintra (10). Hot glue is applied on the curved portion of the hairpin clip (40) between the hairpin clip (40) and the sintra (10). The straight side of the hairpin clip (40) remains glue free. A small interior cavity created in the bottom half of the backer rod (50) houses the glued hairpin clip (40) secured to the brass tube (20) protruding from the bottom of the sintra (10). The halves of the backer rod (50) are glued to the top and bottom of the sintra (10). The top portion of the brass tube (20) goes through and is flush with the top of the backer rod (50). FIG. 3B illustrates a completed puppet and wrist insert.

### DESCRIPTION—FIGURES ADDITIONAL EMBODIMENT

Not applicable.

### ADVANTAGES

From the descriptions given above, advantages of the puppet rod and wrist manipulation system are evident:

a) Puppet arm movement is expanded and more realistic including movement in a vertical line, rotation of the wrist joint, increased range of motion etc.

b) Construction materials are commonly available and inexpensive.

c) The puppet rod and wrist manipulation system can be modified to scale to use in puppets of varying size.

d) The system provides a secure rod arm/puppet connection that will not damage the puppet. This would include things such as compression of the wrist joint and deterioration of the fabric.

e) The small connection located in the wrist is unobtrusive, and will not detract visually.

f) The rod arm/puppet connection remains secure unless intentionally disconnected.

### OPERATION—MAIN EMBODIMENT

Hand held puppet rod arm technology has been in need of advancement beyond straight wire and rubber bands for decades. The puppet arm and wrist manipulation system is comprised of 2 parts, the wrist insert, FIG. 3B, and the rod (60). These combine to advance the art of puppetry to a new level.

The wrist insert, FIG. 3B, provides the connection requirement between the rod (60) and puppet arm. This is accomplished in a hidden manner thus giving the puppet arm a natural look. The sintra (10) base provides stiff support for the brass tube (20). Any rigid material to scale could serve as the base (10). The brass tube (20) is secured to the sintra (10) using two number 6 bolt retainers (30). The hairpin clip (40) secured to the groove in the brass tube (20) with hot glue, provides friction to the inserted rod (60). This prevents unwanted disconnects. At the same time, rotation between the rod (60) and the puppet arm is not restricted. The backer rod (50) provides support and shape for the puppet wrist, as well as assuring proper placement of the sintra (10)/brass tube (20) assembly within said wrist. Rod manipulation for the puppeteer using this system remains essentially the same as the current art. However, the puppeteer will find that they can demonstrate movements, that until now, have been impossible.

### OPERATIONS—ALTERNATIVE EMBODIMENTS

Not applicable.

### CONCLUSION, RAMIFICATIONS AND SCOPE

Accordingly, the reader will understand that this invention, a rod arm puppet movement system, provides the ability to engage in realistic puppet arm movement. The system allows for an extremely secure attachment that can be disconnected when necessary. The securement area is virtually invisible with all connection and disconnection activity occurring at one very small internal point. This leaves the puppet wrist joint essentially untouched. Although the above description contains many specifics, limitations of usage should not be placed on the scope of this invention. These examples should be considered illustrations of the currently preferred embodiments of this invention.

Many variations of usage are possible with this device. For example, this invention could provide connection and support for props. Used in performance, it would allow for easy disconnection between the support rod and the props as needed. In addition, this invention could, with modification of the components to scale, allow for mounting of decorative devices that would consequently have rotational axis movement.

Thus the examples given should not determine the scope of this invention. Rather, the scope of the invention should be determined by the appended claims and their legal equivalents.

1. A connection and movement system comprising:
a) a tubular support structure encasing a base containing a tube and clip device secured by retainers to said base.
b) said tube and clip device of sufficient size to accommodate appropriately sized wire.
c) means for securing said wire to said tube and clip device whereby said wire inserted into said tube and clip device allows connection and movement.
